(19) United States
(12) Patent Application Publication
(10) Pub. No.: US 2012/0257521 A1
(43) Pub. Date: Oct. 11, 2012

(54) ADAPTIVE GUARD INTERVAL FOR WIRELESS COEXISTENCE

(75) Inventor: SARIN S. MEHTA, Mountain View, CA (US)

(73) Assignee: QUALCOMM, Incorporated, San Diego, CA (US)

(21) Appl. No.: 13/083,796

(22) Filed: Apr. 11, 2011

(51) Int. Cl. H04W 24/00; H04L 12/26; H04W 72/04

(52) U.S. Cl. 370/252; 370/329

(57) ABSTRACT

A coexistence interval includes a second part used by a second wireless network (for example, WLAN) and a first part used by a first wireless network (for example, Bluetooth). A Guard Interval (GI) defines an amount of time at the end of the second part and before the beginning of the first part during which communications in the second wireless network are not initiated. The amounts of time required to complete individual communications in the second network are measured and are used to change the rate of GI adjustment. In one example, if measurement values are fairly constant then the GI is adjusted at a slower rate, whereas if the stream of measurement values exhibits a relatively substantial and sustained increase then the rate of GI adjustment is increased. The GI and the rate of GI adjustment are dynamically adjusted based on response time measurement values.

### BACKGROUND INFORMATION

1. Technical Field

The present disclosure relates to wireless coexistence, and more particularly to the determining of a Guard Interval in a wireless coexistence environment.

2. Background Information

Bluetooth (BT) and WLAN (Wireless LAN) are two competing radio technologies that operate on the same 2.4 GHz unlicensed band. WLAN is standardized in IEEE 802.11 and has several variants including the most recent IEEE 802.11(n). Bluetooth is a commercial implementation of a Wireless Personal Area Network (WPAN) technology standardized in IEEE 802.15.1. In one example, WLAN transceiver circuitry and Bluetooth transceiver circuitry are both located in the same cellular telephone device. The WLAN transceiver circuitry may be used to transfer data files between the WLAN transceiver circuitry in the cellular telephone and a WLAN Access Point (AP). Digital music files may, for example, be communicated from the AP to the cellular telephone in this way. The Bluetooth transceiver circuitry may be used to link the cellular telephone to a wireless headset. The user may, for example, listen to music stored on the cellular telephone using the Bluetooth wireless headset so that music information is streamed via the Bluetooth link from the Bluetooth transceiver circuitry in the cellular telephone to the Bluetooth headset. Both transceivers (WLAN and Bluetooth) share the same single physical antenna in the cellular telephone, with the WLAN transceiver controlling which transceiver will be coupled to the antenna.

Packets of voice music/data may be communicated across the Bluetooth link from the cellular telephone to the wireless headset. So that music/voice to the user is not interrupted, the Bluetooth transceiver in the cellular telephone must be given control of the antenna at regular times. Bluetooth uses a Synchronous Connection-Oriented (SCO) circuit-switched connection for reserved bandwidth communications like voice. A SCO connection utilizes two slots of a Bluetooth interval (each BT SCO slot is 625 microseconds in duration) for voice data. The length of the Bluetooth interval depends on the type of Bluetooth packets used. Typically the whole interval is 3.75 milliseconds or 7.5 milliseconds long. Of this interval, the Bluetooth transceiver needs use of the antenna for a 1.25 millisecond subinterval (two 625 microsecond BT SCO slots). The remainder of the interval is available for WLAN use. The WLAN transceiver is given access to the antenna during certain slots of the interval, and the Bluetooth transceiver is given access to the antenna during other slots of the interval, and so forth back and forth, from BT interval to BT interval. Accordingly, the AP may communicate multiple data packets to the WLAN transceiver circuitry in the cellular telephone (referred to as a station (STA)) in a 2.50 millisecond subinterval. It may take different amounts of time for different WLAN data packets to be communicated, but in general, if environmental conditions do not change, data packets that carry data of a file are of the same or similar durations, except for the last data packet that may be of a smaller duration.

Such data packets may be communicated in the following way. First, when in the power save mode the STA in the cellular telephone sends the AP a packet called a “Power Save Poll” packet (a “PS-Poll” packet). This packet tells the AP to send back one WLAN downlink data packet. When the STA receives the requested data packet, it returns an acknowledgment (ACK) packet to the AP. The header of the downlink data packet includes a bit that tells the STA whether the AP has more buffered data to send or not (whether there are more WLAN data packets for this data file or not). If the bit indicates that the AP has more data to send, then the STA sends the AP another PS-Poll packet. This is a request that the AP send the STA one more WLAN data packet. In this way, the STA requests each successive data packet from the AP and manages data flow from the AP in this way. When the time comes that the antenna should be given to the Bluetooth transceiver, the STA must not ask for another data packet to be sent from the AP if there is not enough time remaining in the current subinterval for the communication of the data packet to be completed before the antenna is to be handed over for Bluetooth use. The STA therefore may maintain a timer or other mechanism to determine when the end of the current subinterval will occur. The STA uses this timer or other mechanism to engage in decision-making to determine whether or not to send a PS-Poll packet to request a data packet from the AP.

The amount of time necessary to communicate a packet from the AP to the STA data packet is not always the same. For example, the AP can slow the data rate, and this may cause communication of a data packet to take longer than it otherwise would if a faster data rate were used. If the AP determines that too many data packets have not been correctly received, then the AP may decide to slow the data rate to improve reliability of the WLAN communication link. The amount of time it will require to communicate the next data packet from the AP to the STA in the cellular telephone is generally not known to the STA.

The STA typically uses a Guard Interval (GI) of time. If the current instant in time is within the GI of the end of the current subinterval (the subinterval in which WLAN communications are possible), then the STA will not send out a PS-Poll packet. A problem can occur if a PS-Poll packet is sent out and there is not enough time for the AP to complete sending back the requested data packet. The AP may receive the PS-Poll packet and begin to send the data packet to the STA, but before the transfer is complete the subinterval may end. The STA in the cellular telephone will give access of the antenna to the Bluetooth transceiver. The Bluetooth transceiver may use the antenna to communicate Bluetooth information successfully due to the way Bluetooth and WLAN work despite the fact that the AP is still sending the requested data packet. The STA in the cellular telephone, however, will not receive the WLAN data packet because the STA is no longer coupled to the antenna. The STA therefore does not return an ACK. When the AP does not receive an ACK for the data packet it just sent, it may respond by resending the data packet and doing so with a slower data rate. The slower data rate is used to increase the probability that the retransmitted data packet will be successfully received. The antenna, however, is still being used by the Bluetooth transceiver, so the STA in the telephone handset does not ACK the retransmitted data packet. This cycle can repeat itself such that the data rate is ratcheted down to be so low that the next time the antenna is available for use by the WLAN STA the data packet takes so long to communicate that it cannot be communicated in one interval. The WLAN link may fail in what is colorfully referred to as the “spiral of death”. It is therefore important that the Guard Interval (GI) not be set to be too small. It is also undesirable that the GI be set to be too large. If the GI is set to be too large, then there is less time available in the interval for the AP and STA to communicate WLAN information. WLAN communication bandwidth is decreased, and this is undesirable.

### SUMMARY

A coexistence interval includes a second part used by a second wireless network (for example, a WLAN network) and a first part used by a first wireless network (for example, a Bluetooth network). A Guard Interval (GI) defines an amount of time at the end of the second part and before the beginning of the first part during which communications in the second wireless network are not initiated. The amounts of time required to complete individual communications in the second network are measured. The resulting measurements are used to change the rate of GI adjustment. In one example, if the values of the stream of measurement values are fairly constant then the GI is adjusted at a slower rate, whereas if the values of the stream of measurement values exhibit a relatively substantial and sustained increase then the rate of GI adjustment is increased. The GI and the rate of GI adjustment are dynamically adjusted based on response time measurement values.

In one specific example, the coexistence interval is a Bluetooth interval involving six slots, the first network is a Bluetooth network, and the second network is a WLAN network. A WLAN station (STA) functionality in a mobile communication device such as a cellular telephone carries out a GI-determining method. The STA measures the response time of an WLAN AP and thereby determines a Response Time Measurement Value (RTMV). The STA may make this measurement by determining an amount of time that transpires between a first time and a second time. The first time is a time when the STA transmits a PS-Poll in a power save mode to the AP to request the AP send the STA back one downlink data packet. The second time is a time when the STA transmits an acknowledgement (ACK) back to the AP to acknowledge receipt of the requested downlink data packet. This is but one way of measuring AP response time. Other ways of measuring AP response time are possible.

The STA functionality in the cellular telephone then determines when to update the GI based at least in part on the new RTMV. For example, if the new RTMV does not indicate that a substantial and sustained change has occurred from the stream of previous RTMVs, then the GI may be updated at a lower rate. In this case, the GI may be updated only once every ten RTMVs. At the time of update, the value of the new GI may be determined by the STA to be the second largest RTMV value of the last ten RTMV values collected. If, however, the new RTMV does indicate that a substantial and sustained change from previous RTMVs has occurred, then the STA may update the GI at a higher rate. For example, if the RTMV is one of a certain number of RTMVs in a window of three RTMV values after a GI change, and if the new RTMV is larger than the current GI, then the STA may immediately update the GI to be the second largest RTMV value of the last ten RTMV values collected. The GI in use is only changed to the updated GI value at the beginning of a new coexistence interval. Once the STA has started to use a GI in a particular coexistence interval, the GI is not changed during that coexistence interval. This is but one possible function for changing the rate of GI adjustment as a function of RTMV values. Other functions for receiving RTMV values and for determining when and how to update the GI based on RTMV values are possible. The novel aspect of determining when to adjust the GI based at least in part on one or more RTMV values is not limited to any one particular function.

In one example, the novel GI-determining and rate adjustment method makes GI adjustment more responsive to increasing AP response times as compared to conventional GI adjusting methods. Reductions in data rate made by the AP due to a loss of an ACK that would otherwise cause WLAN link failures in conventional GI adjusting methods do not cause WLAN link failures using the novel GI-determining and rate adjustment method. A lost ACK may result in the AP reducing data rate, but the GI is adjusted and lengthened fast enough that subsequent ACKs are not lost and such that the AP does not continue to decrease data rate. The WLAN link failure mechanism referred to as the “spiral of death” is foiled.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 is a diagram of one exemplary system that can carry out a method of dynamically updating and adjusting a coexistence Guard Interval (GI) based at least in part on Response Time Measurement Values (RTMVs).

FIG. 2 is a more detailed diagram of the cellular telephone of the system of FIG. 1.

FIG. 3 is a timeline diagram that shows a sequence of four consecutive coexistence intervals.

FIG. 4 is a more detailed diagram of one coexistence interval.

FIG. 5 is a timeline diagram that illustrates one method by which a GI can be updated.

FIG. 6 is a timeline diagram that illustrates another method by which a GI can be updated.

FIG. 7 is a flowchart of a method of determining when to update a GI and for subsequently updating the GI to the proper value at the appropriate time.

FIG. 8 is a flowchart diagram of a method of using the updated GI to schedule communications in a coexistence interval.

FIG. 9 is a timeline diagram of that illustrates an example of the methods of FIG. 7 and FIG. 8 in operation.

FIG. 10 is a diagram of another example of a coexistence interval, where an adjustment rate of a guard interval in the coexistence interval is changed in accordance with a GI adjustment rate method.

FIG. 11 is a flowchart of a specific example of the method of FIG. 7.

FIG. 12 is another diagram illustrative of a Guard Interval adjustment rate changing method.

FIG. 13 is a diagram that illustrates how the method of determining an updated GI and of determining when to use the updated GI can be performed by a generic processor.

FIG. 14 is a diagram that illustrates how the method of determining an updated GI and of determining when to use the updated GI can be performed by a dedicated hardware engine.

FIG. 15 is a diagram that illustrates how the method of determining an updated GI and of determining when to use the updated GI can be performed by a processor in the base band processor in the transceiver circuitry for communicating in the second wireless network.

FIG. 16 is a diagram that illustrates how the method of determining an updated GI and of determining when to use the updated GI can be performed by an RF transceiver integrated circuit that has multi-function radio blocks.

FIG. 17 is a diagram that illustrates how the method of determining an updated GI and of determining when to use the updated GI can be performed by functionality outside the device that uses the updated guard intervals to schedule transmissions.

### DETAILED DESCRIPTION

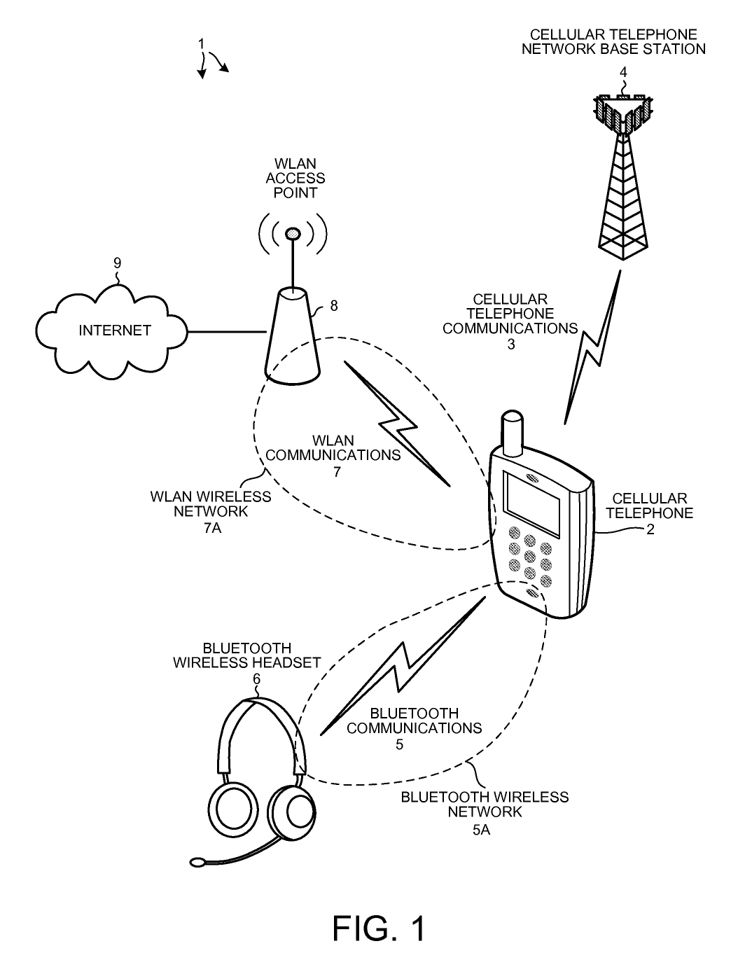

FIG. 1 is a diagram of a system 1 that carries out a method of dynamically updating and adjusting a Guard Interval in a coexistence environment involving two simultaneously used wireless networks and a shared communication channel. The method can be carried out by numerous different types of devices in numerous different types of systems. System 1 is but one example of a system in which the method can be carried out.

System 1 includes a mobile communication device such as cellular telephone 2. Cellular telephone 2 has cellular telephone transceiver circuitry, Wireless Local Area Network (WLAN) transceiver circuitry, and Bluetooth (BT) transceiver circuitry. The cellular telephone transceiver circuitry is usable for engaging in cellular telephone communications in a cellular telephone network. The cellular telephone communications are represented by arrow 3 and the cellular telephone network is represented by the symbol of the base station 4. The Bluetooth transceiver circuitry within cellular telephone 2 is usable for engaging in Bluetooth communications in a Bluetooth wireless network 5A. In the example illustrated, the BT communications are represented by arrow 5. The cellular telephone transmits Bluetooth communications to and receives Bluetooth communications from a wireless Bluetooth headset 6. The Bluetooth communications are compliant with an IEEE 802.15.1 standard. The WLAN transceiver circuitry within cellular telephone 2 is usable for engaging in WLAN communications in a WLAN wireless network 7A. The WLAN communications are compliant with an IEEE 802.11 standard. In the example illustrated, the communications are represented by arrow 7. The WLAN transceiver circuitry within the cellular telephone transmits communications to and receives communications from a WLAN Access Point (AP) 8. AP 8 is in turn networked to the Internet 9.

The WLAN functionality and the Bluetooth functionality of the cellular telephone 2 are said to coexist in that they can operate simultaneously in the same 2.4 GHz unlicensed band using a time-multiplexing scheme. In the described example, a digital file such as a music MP3 file is downloaded from the internet 9 via AP 8 and to the WLAN transceiver circuitry within cellular telephone 2. In this way, the file of music is downloaded into the cellular telephone. At the same time this downloading is occurring, data representing voice is sent from the Bluetooth transceiver circuitry of cellular telephone 2 to the Bluetooth headset 6 so that a user can use headset 6 to hear another participant in a telephone conversation.

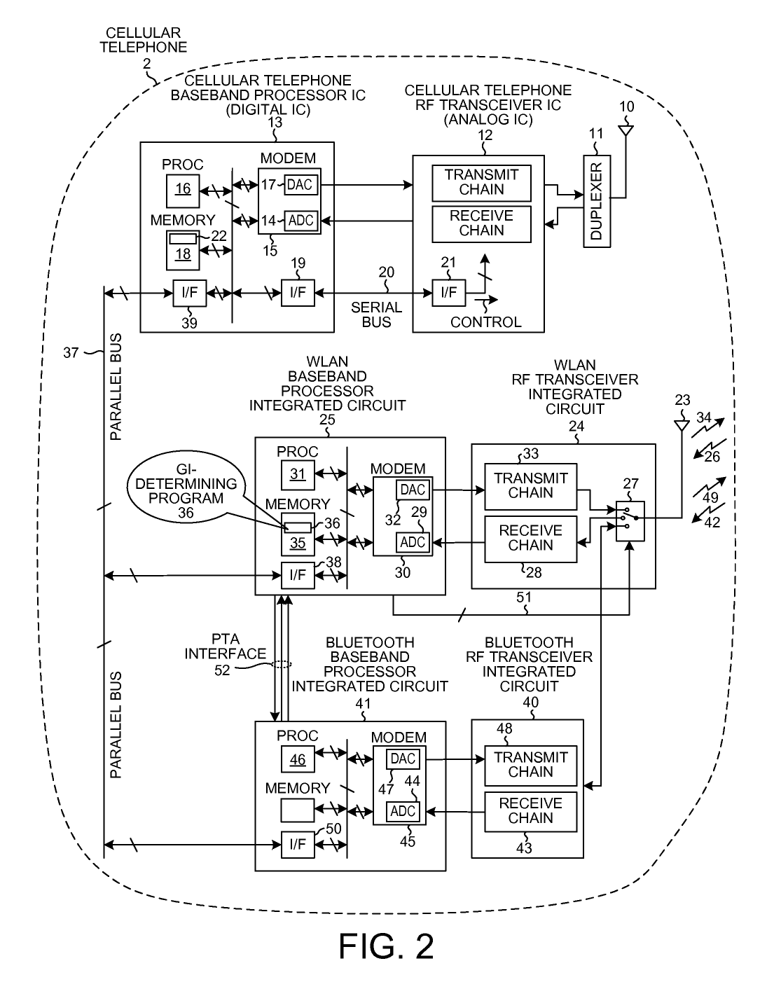

FIG. 2 is a more detailed diagram of the cellular telephone 2. From the highest perspective, the cellular telephone transceiver circuitry, the WLAN transceiver circuitry, and the Bluetooth transceiver circuitry all have similar circuit topologies in that each includes a RF transceiver integrated circuit and each includes a baseband processor integrated circuit. The cellular telephone transceiver circuitry, for example, includes an antenna 10, a duplexer 11, a cellular telephone RF transceiver integrated circuit 12, and a cellular telephone baseband processor integrated circuit 13. A cellular telephone communication received onto antenna 10 passes through duplexer 11, and to the receive chain in the RF transceiver integrated circuit 12. The RF signal is amplified, downconverted, and the resulting downconverted signal is filtered by the receive chain, and is then converted into digital form by an Analog-to-Digital Converter 14 in the baseband processor integrated circuit. The resulting digitized information is transformed, demodulated, demapped, and decoded as necessary by modem circuitry 15 so that the digital information communicated is available to processor 16. If information is to be transmitted, then the digital information to be communicated from the processor 16 is coded, mapped, modulated, and transformed by modem 15. After being converted into analog form by a Digital-to-Analog Converter (DAC) 17, the resulting analog information is filtered, upconverted, and amplified for transmission by a transmit chain. The amplified signal is then transmitted from antenna 10 as a cellular telephone communication. The processor 16 executes programs of processor-executable instructions stored in memory 18. These programs 22 include an operating system for controlling the overall cellular telephone, and include high layers of a WLAN protocol processing stack and high layers of a Bluetooth protocol processing stack. The digital baseband processor integrated circuit 13 controls the receive chain and the transmit chain via serial bus interface 19, serial bus 20, and serial bus interface 21.

Considered at the highest level, the WLAN transceiver circuitry is of similar topology to the cellular telephone transceiver circuitry. The WLAN transceiver circuitry includes an antenna 23 (that it shares with the Bluetooth functionality), a WLAN RF transceiver integrated circuit 24, and a WLAN baseband processor integrated circuit 25. High level operation of the WLAN circuitry is similar to the high level operation of the cellular telephone circuitry. If a WLAN signal 26 is to be received, the WLAN signal passes from antenna 23, through antenna switch 27, and into the receive chain 28 in the WLAN RF transceiver integrated circuit 24. The WLAN signal is amplified, downconverted, and the resulting downconverted signal is filtered, and then converted into digital form by an Analog-to-Digital Converter 29. The resulting digitized information is demodulated and processed further as necessary by modem 30 so that the digital information being communicated is available to a processor 31. If information is to be transmitted, then the digital information to be communicated is modulated and otherwise processed by modem 30, and is then converted into analog form by a Digital-to-Analog Converter (DAC) 32. The resulting analog information is filtered, upconverted, and amplified by the transmit chain 33 of the WLAN RF transceiver integrated circuit 24. The upconverted and amplified WLAN signal passes through antenna switch 27 and to antenna 23 for transmission as signal 34. The processor 31 executes programs of processor-executable instructions stored in memory 35. These programs include part of the WLAN protocol processing stack including a GI-determining and GI rate adjustment program 36 of instructions as explained in further detail below. The WLAN digital baseband processor integrated circuit 25 is coupled to communicate with the cellular telephone digital baseband processor integrated circuit 13 via parallel bus 37 and parallel bus interfaces 38 and 39.

The Bluetooth transceiver circuitry includes the antenna 23 (that is shared with the WLAN functionality), a Bluetooth RF transceiver integrated circuit 40 and a Bluetooth baseband processor integrated circuit 41. If a Bluetooth signal 42 is to be received, the Bluetooth signal passes from antenna 23, through antenna switch 27, and into the receive chain 43 in the Bluetooth RF transceiver integrated circuit 40. The Bluetooth signal is amplified, downconverted, and the resulting downconverted signal is filtered, and then converted into digital form by an Analog-to-Digital Converter 44. The resulting digitized information is demodulated and processed further by modem 45 so that the digital information being communicated is available to a processor 46. If information is to be transmitted, then the digital information from processor 46 is modulated and otherwise processed by modem 45, and is then converted into analog form by a Digital-to-Analog Converter (DAC) 47. The resulting analog information is filtered, upconverted, and amplified by transmit chain 48. The upconverted and amplified Bluetooth signal passes through antenna switch 27 and to antenna 23 for transmission as signal 49. The Bluetooth digital baseband processor integrated circuit 41 is also coupled to communicate with the cellular telephone digital baseband processor integrated circuit 13 via parallel bus 37 and parallel bus interfaces 50 and 39.

The WLAN baseband processor integrated circuit 25 controls access to the WLAN/BT coexistence antenna 23 by controlling antenna switch 27 via digital control signals on signal conductors 51. The Bluetooth and WLAN transceivers operate in a time-division multiplexed manner in the sense that only one of them sends or receives packets of information at a given time. Neither one transmits or receives continuously. Communication of a packet requires from hundreds of microseconds to a number of milliseconds. In order to communicate successfully, an entire packet must generally be sent and a response must be received in return. In the illustrated example, an arbiter is located in the WLAN baseband processor integrated circuit 25. This arbiter may give access to antenna 23 to the Bluetooth transceiver, or the arbiter may not grant access so that the WLAN transceiver can have access to the antenna 23. Once the arbiter gives access to the Bluetooth transceiver, the Bluetooth transceiver must complete a piece of communication such as by sending a message and receiving a response. After the Bluetooth device has completed this communicating, the WLAN arbiter may take back control of the antenna 23 so that the antenna can then be used for WLAN communications. Communication proceeds in this way with the two transceivers taking turns using the antenna.

In order to carry out this time-division multiplexing scheme, the Bluetooth transceiver circuitry needs to communicate timing-precise information to the WLAN transceiver. This timing-precise information indicates, among other things, exactly when the Bluetooth device will be transmitting and when it will be stopping. A three-conductor interface involving conductors 52, referred to as a Packet Traffic Arbitration (PTA) bus and interface mechanism, is provided to allow the WLAN and Bluetooth transceiver circuits to exchange information such that the arbiter in the WLAN baseband processor integrated circuit 25 can control access to antenna 23 properly.

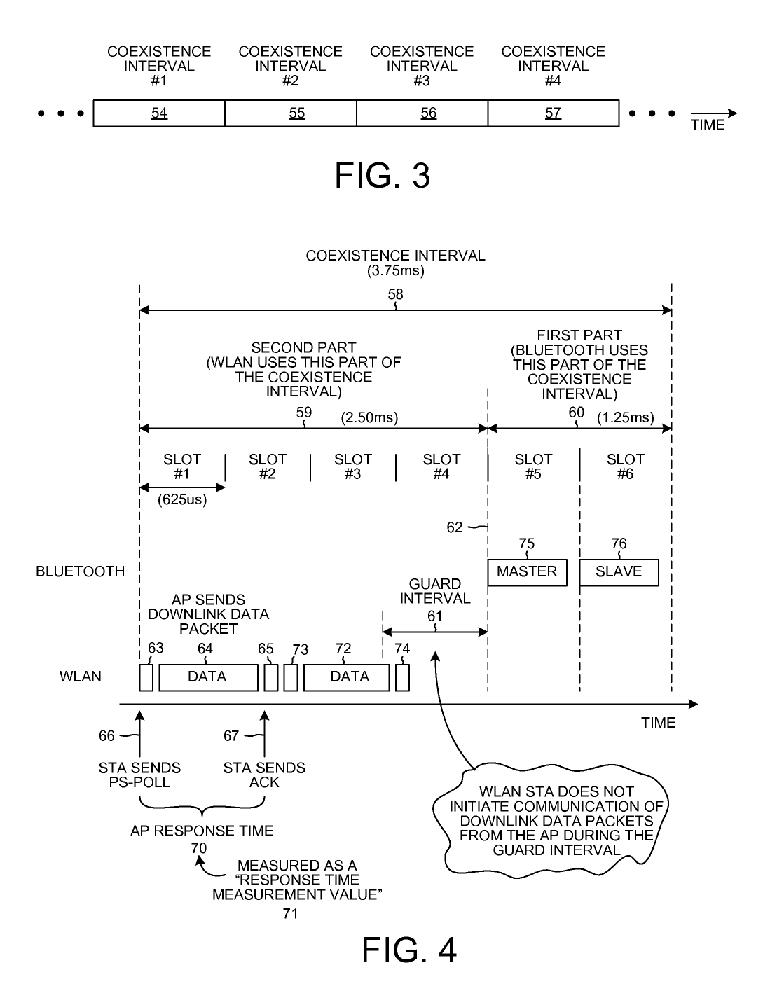

FIG. 3 is a timeline diagram that shows a sequence of four BT coexistence intervals 54-57. Time in the diagram extends from left to right. Each of the BT coexistence intervals includes a first part (BT slot numbers 5 and 6) that is usable for Bluetooth communication. Each of the coexistence intervals also includes a second part (BT slot numbers 1-4) that is not used for Bluetooth communication. The WLAN transceiver circuitry can use this second part of each coexistence interval to communicate WLAN information. As time proceeds from left to right in the diagram, the WLAN transceiver circuitry may communicate WLAN information during the second part of the first coexistence interval, then the Bluetooth transceiver circuitry may communicate Bluetooth information in the first part of the first coexistence interval, then the WLAN transceiver circuitry may communicate WLAN information in the second part of the second coexistence interval, then the Bluetooth transceiver circuitry may communicate Bluetooth information in the first part of the second coexistence interval, and so forth back and forth in time-multiplexed fashion.

FIG. 4 is a more detailed diagram of a BT coexistence interval 58. BT coexistence interval 58 is representative of any one of the coexistence intervals 54-57 of FIG. 3. As indicated by FIG. 4, the coexistence interval is 3.75 milliseconds long and involves six BT slots. The BT slots are numbered one to six. The second part 59 of the coexistence interval is the subinterval used for WLAN communications. Second part 59 involves slot numbers one, two, three and four. The first part 60 of the coexistence interval is the subinterval used for Bluetooth communications. First part 60 involves slot numbers five and six.

The WLAN transceiver circuitry in the cellular telephone 2 maintains a timing mechanism usable to determine when the beginning of each second part 59 occurs and when the ending of each second part 59 occurs. It is important that the WLAN transceiver circuitry not be using the antenna 23 when the Bluetooth transceiver is to start using the antenna 23 at the beginning of slot number 5. To prevent the WLAN AP 8 from transmitting downlink data packets for such a long duration that the WLAN transmissions extend into slot number 5, downlink data packets are requested individually one at a time from the AP using the Power Save Poll mechanism in the WLAN power save mode. The WLAN transceiver circuitry in the cellular telephone 2 is referred to as a WLAN station, or simply the “STA”. The STA requests that the AP 8 send one downlink data packet back to the STA by transmitting a PS-Poll transmission to the AP. The AP responds by sending the requested downlink data packet to the STA. The STA responds that the data packet was successfully received by sending the AP an Acknowledgement (ACK). The STA does not send out any PS-Poll communications within a Guard Interval (GI) 61 amount of time of the end 62 of the second part 59 of the coexistence interval 58. If the GI is of the same time duration as the time required to complete the next AP downlink data packet communication, then the STA not issuing a PS-Poll within the guard time serves to allow downlink data packet communications to occur if enough time remains until the end 62 of the second part 59, but does not prompt an additional downlink data packet communication if there is not enough time remaining for such an additional communication to be completed before the end 62 of the second part 59.

In the specific example of FIG. 4, communication of a first WLAN downlink data packet involves the STA sending a PS-Poll frame 63 to the AP 8. The AP 8 responds by transmitting back the requested data packet 64. The STA receives the downlink data packet 64 and indicates it successfully received the data by transmitting back to the AP an ACK 65. The duration from the time when the transmitting of the PS-Poll starts (as indicated by arrow 66) until the time when the transmitting of the ACK starts (as indicated by arrow 67) is referred to as an “AP response time” 70. The AP response time can vary from the communication of downlink data packet to downlink data packet. The STA makes a measurement of the AP response time, thereby generating a corresponding value that is referred to here as a Response Time Measurement Value (RTMV). The RTMV for AP response time 70 is identified in FIG. 4 by reference numeral 71. The RTMV is indicative of the duration of the AP response time 70. The duration of each AP response time is measured and recorded in this way. The resulting RTMVs are used, as described further below, by the STA to determine when to update the GI and to determine what value the updated GI will have. In the diagram of FIG. 4, second PS-Poll 73 is sent to the AP. The AP responds by sending back a second AP downlink data packet 72. Receipt of the second AP downlink data packet 72 is acknowledged by the STA sending a second ACK 74. The Bluetooth master makes a transmission 75 in BT slot #5 and the Bluetooth slave makes a transmission 76 in BT slot #6. The WLAN STA in the cellular telephone 2 does not initiate communication of WLAN downlink data packets from the AP once the current time is within a GI of the end 62 of the end of the second part 59 of the coexistence interval.

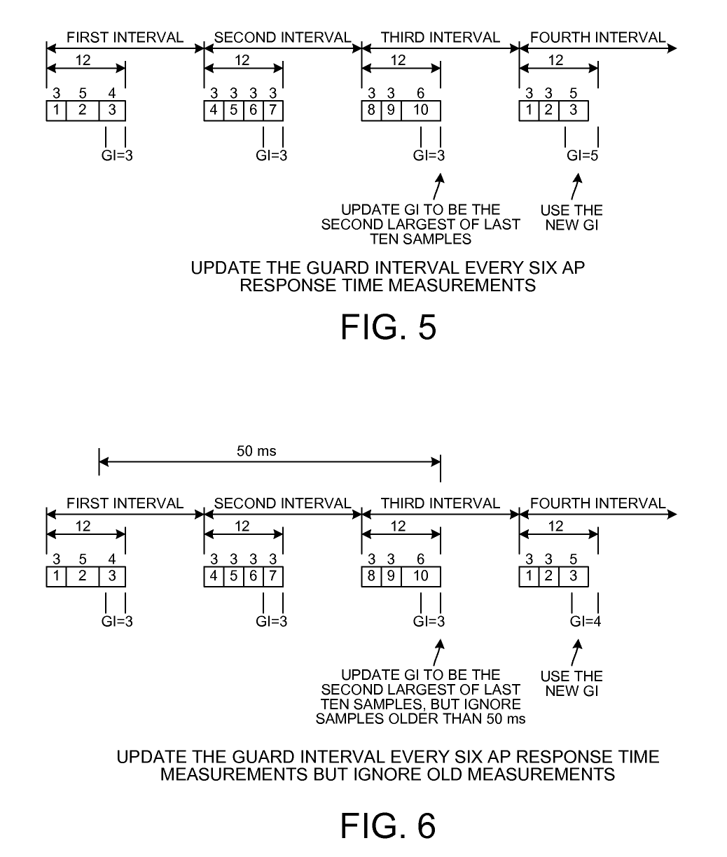

FIG. 5 is a diagram that illustrates one method by which the Guard Interval (GI) can be updated. Time in the diagram extends from left to right. The blocks extending from left to right in the diagram illustrate AP downlink data packet communications including the PS-Poll portion and the downlink data packet portion. The number above a block denotes the AP Response Time Measurement Value (RTMV) corresponding to the AP downlink data packet communication. The number in a block denotes the number of the communication. There are thirteen consecutive AP downlink data packet communications in the example of FIG. 5 and they are denoted “1”, “2, “3” and so forth to “10”, and then “1”, “2” and “3”. The first three such AP downlink data packet communications are communicated in first coexistence interval. More particularly, the three AP download data packets denoted “1”, “2” and “3” are communicated in the second part of the first coexistence interval, where the second part of the coexistence interval is not used for Bluetooth communication. The second part of each coexistence interval has a duration of twelve time units as illustrated.

Following this second part of the first coexistence interval there is a first part (not shown) of the first coexistence interval in which Bluetooth communications occur. Then following this first part (not shown) of the first coexistence interval, the next four AP downlink data packets denoted “4, “5”, “6” and “7” are communicated in the second part of the second coexistence interval. Then following this second part of the second coexistence interval is a first part of the second coexistence interval (not shown) used for Bluetooth communications. The next three AP downlink data packets denoted “8”, “9” and “10” are then communicated, as so forth. The notation “GI=3” at the end of each of the first three coexistence intervals (actually the end of the second part of each coexistence interval) indicates that the guard interval in use during that interval has a value of “3”.

In the method illustrated in FIG. 5, ten consecutive AP response time measurements are made to generate ten consecutive RTMVs. Throughout the time these measurements are being made, the GI in use is not changed as indicated by the “GI=3” notation. Once the tenth RTMV has been determined, the new GI can be determined. In accordance with the GI-determining method described in connection with FIG. 5, the updated GI is determined to be the second largest RTMV of the last ten RTMVs. In the illustrated example, the largest RTMV of the last ten RTMVs is the RTMV number “10” of value “6” and the second largest RTMV of the last ten RTMVs is the RTMV number “2” of value “5”. Accordingly, the updated GI is determined to be “5”. This newly updated GI value of “5” is then used to be the new GI value starting at the beginning of the next coexistence interval. Note the “GI=5” notation under the representation of the fourth coexistence interval. This GI-determining process is then repeated. Ten more AP response times are measured, and thereafter the next GI is determined to be the second largest of the last ten RTMVs. This process is repeated over and over with the GI being updated once every ten RTMVs.

FIG. 6 is a diagram that illustrates a variant of the GI-determining method of FIG. 5. In the GI-determining method of FIG. 6, the GI is also updated after ten RTMVs have been logged as in the method of FIG. 5, but in the method of FIG. 6 at the time when the value of the new GI is determined any RTMV values that are older than a predetermined age are ignored. In the specific example of FIG. 6, ten RTMV values are determined, and these are denoted “1”, “2”, “3” and so forth to RTMV “10”. RTMV “10” has a value of “6” and is the last RTMV of the third coexistence interval. After the tenth RTMV has been determined, a new GI is determined for use in the next coexistence interval. The second largest RTMV value of the last ten RTMV values is to be new GI value, but any RTMV values older than fifty milliseconds are ignored for this purpose. The second largest RTMV value of the ten is therefore not the “5” value of the second RTMV number “2” because RTMV number “2” was determined more than fifty milliseconds before the time when the new GI is being determined. The second largest RTMV value is therefore the “4” value of the third RTMV number “3”. Note that the GI value used in the fourth coexistence interval at the right of the diagram is “4” as indicated by the notation “GI=4”. Although the sequence of RTMVs in the examples of FIG. 5 and FIG. 6 is the same, the new GI values determined differ due to the different GI-determining methods employed.

Although the GI-determining methods of FIG. 5 and FIG. 6 work well in some environments, it has been determined these methods respond to a lengthening of RTMV values too slowly in some situations, and can result in a failure mechanism (for example, the failure mechanism described above in the Background Information section) in which the AP decreases the data rate so fast that the WLAN link fails.

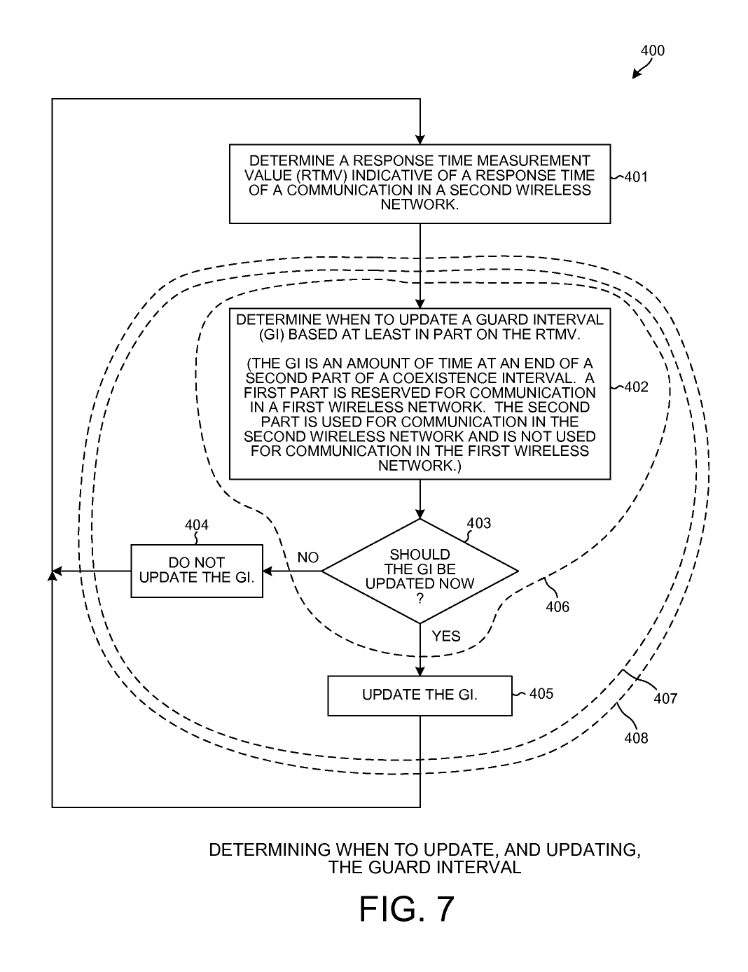

FIG. 7 is a flowchart of a method 400 of determining when to update a Guard Interval (GI) and then subsequently updating the GI at the appropriate time. A Response Time Measurement Value (RTMV) is determined (step 401), where the RTMV is indicative of the duration of an AP response time in a second wireless network. In this case, the second wireless network is the WLAN network and the first wireless network is the Bluetooth network. The WLAN STA portion of cellular telephone 2 transmits a PS-Poll communication to AP 8. The PS-Poll communication is a request that the AP send back one downlink data packet. The AP 8 receives the PS-Poll communication and in response sends back a downlink data packet. The STA then receives the downlink data packet and in response sends the AP an ACK. As described above in connection with FIG. 4, the amount of time between the time when the STA starts to transmit the PS-Poll and the time when the STA starts to transmit the ACK is the AP response time. The STA measures this AP response time and records it as the RTMV.

The STA portion of cellular telephone 2 determines (step 402) when to update the GI based at least in part on the RTMV determined in step 401. In one example of the GI-determining method, RTMVs are logged for ten consecutive AP downlink data packet transmissions. The value of the new GI is determined immediately after the first ten RTMVs have been determined. The value of the new GI is the value of the second largest of the last ten recorded RTMVs. When the next AP downlink data packet transmission (the eleventh such AP downlink data packet transmission in this example) occurs, an AP response time measurement is made to obtain an eleventh RTMV. If this eleventh RTMV is larger than the previously determined GI then the GI is immediately updated (to be the value of the second largest RTMV of the last ten RTMVs), whereas if the new RTMV is not larger that the previously determined GI then the GI is not updated at least until a next AP response time is measured. If the GI is not updated, then next AP downlink data packet transmission (the twelfth such transmission in this example) is measured to obtain another RTMV, and if this next RTMV is larger that the previously determined GI then the GI is updated (to be the value of the second largest RTMV of the last ten RTMVs), whereas if the new RTMV is not larger that the previously determined GI then the GI is not updated at least until a next response time is measured. Again, if the GI is not updated, then next AP downlink data packet transmission is measured to obtain another RTMV, and if this next RTMV is larger that the previously determined GI then the GI is updated (to be the value of the second largest RTMV of the last ten RTMVs), whereas if the new RTMV is not larger that the previously determined GI then the GI is not updated. Accordingly, if any one of the next three RTMVs (after the setting of the GI in response to the tenth RTMV) is larger than the previously determined GI, then the GI is immediately updated. If, however, no RTMV value in the window of the next three RTMVs (next three RTMVs after a GI adjustment) is larger than the previously determined GI, then seven more AP response times are measured and seven more RTMVs are logged without updating the GI. After the seventh of these RTMVs is determined, then the previous ten RTMVs are considered and a new GI is determined to be the second largest of these last ten RTMVs. Thereafter, the method repeats in that if any of the next three RTMVs is larger than the last updated GI value, then the GI is immediately updated. If none of the next three RTMVs is larger, then another seven RTMVs are obtained and the next GI is then determined to be the second largest of the last ten RTMVs. This method of measuring AP response times and of updating the GI continues in this way from AP response time, to AP response time.

The result of the determining of step 402 may be a Boolean output value that indicates whether the GI should be updated (in response to the last RTMV) or whether the GI should not be updated (in response to the last RTMV). If it is determined (step 403) that the GI should not be updated in response to the last determined RTMV, then the GI is not changed (step 404). Processing returns to step 401. The GI is unchanged until at least the next AP response time measurement is made. If, however, it is determined (step 403) that the GI should be updated in response to the last determined RTMV, then the GI is updated (step 405). This process of taking AP response time measurements and of updating the GI at appropriate times in accordance with the GI-determining method continues from AP downlink data packet communication to AP downlink data packet communication, from one Bluetooth coexistence interval to the next.

The process of steps 402-403 is a function 406 that receives RTMVs as input values to the function and that outputs a value indicating whether the GI value should be updated or not. The process of steps 402-405 is a function 407 that receives RTMVs as input values to the function and the outputs GI values as outputs of the function. In response to supplying a RTMV to the function, the GI output value may remain unchanged or the GI output value may be updated. The function results in the rate of change of the GI (the frequency with which the GI is changed where frequency is measured with respect to AP response time measurements) increasing to a relatively high rate in response to relatively rapid and sustained increases in RTMV values, and also results in the rate of change of GI decreasing and staying at a relatively low rate if the input RTMV values have relatively constant values.

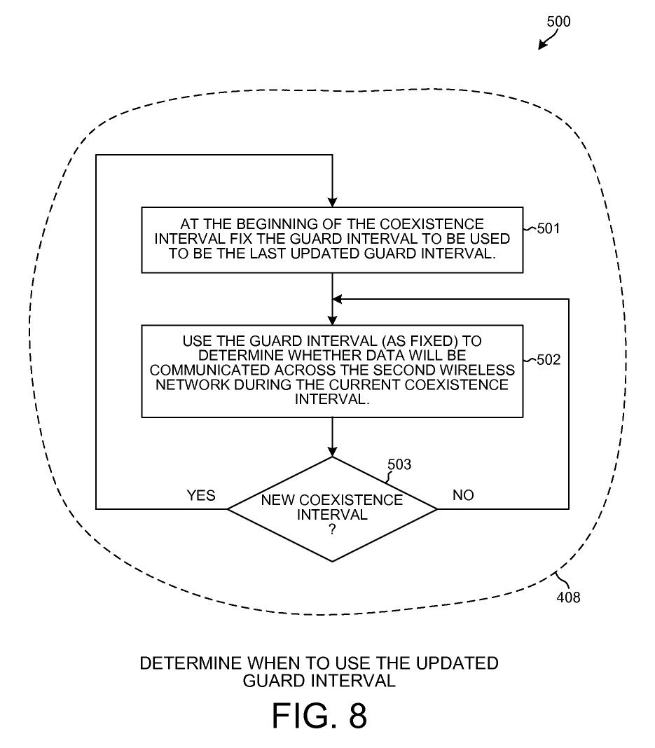

FIG. 8 is a flowchart diagram of a method 500 of determining when to start using the updated GI. The process of steps 402-403 and of steps 501-503 is a function 408 that receives a RTMV as an input value to the function and that outputs a GI value, where the output GI value is the GI value that is in use in determining whether data will be communicated in the coexistence interval. At the beginning of the coexistence interval, the GI to be used in the current coexistence interval is fixed (step 501) to be the last updated GI. The last updated GI is determined according to the method described in connection with FIG. 7. Once the GI to be used is fixed, then that GI is used (step 502) to determine whether to transmit PS-Poll communications during the current coexistence interval. In the case being described here, the second wireless network is the WLAN network and the first wireless network is the Bluetooth network. If more downlink data is to be received by the STA from the AP during the second part of the coexistence interval (the second part of the coexistence interval is the part used by WLAN), then the STA transmits a PS-Poll frame during the current coexistence interval only if the GI has not yet been entered, otherwise if the GI has been entered then the STA does not send a PS-Poll frame. The STA portion of cellular telephone 2 therefore does not transmit PS-Polls to the AP during the GI. Once the STA determines that a new coexistence interval has started (step 503), processing returns to the step of fixing the GI to be the last updated GI (step 501) and the process repeats. Accordingly, only one GI is used throughout the time of a coexistence interval and the value of that one GI is determined at the time of the beginning of the coexistence interval. In the example of FIG. 2, the GI-determining program 36 as executed by processor 31 causes the methods described in connection with FIG. 7 and FIG. 8 to be carried out. The WLAN baseband processor integrated circuit 25 orchestrates and controls the GI-updating and GI-using processes even though other circuitry in the cellular telephone 2 of FIG. 2 is involved in actually carrying out the necessary communications.

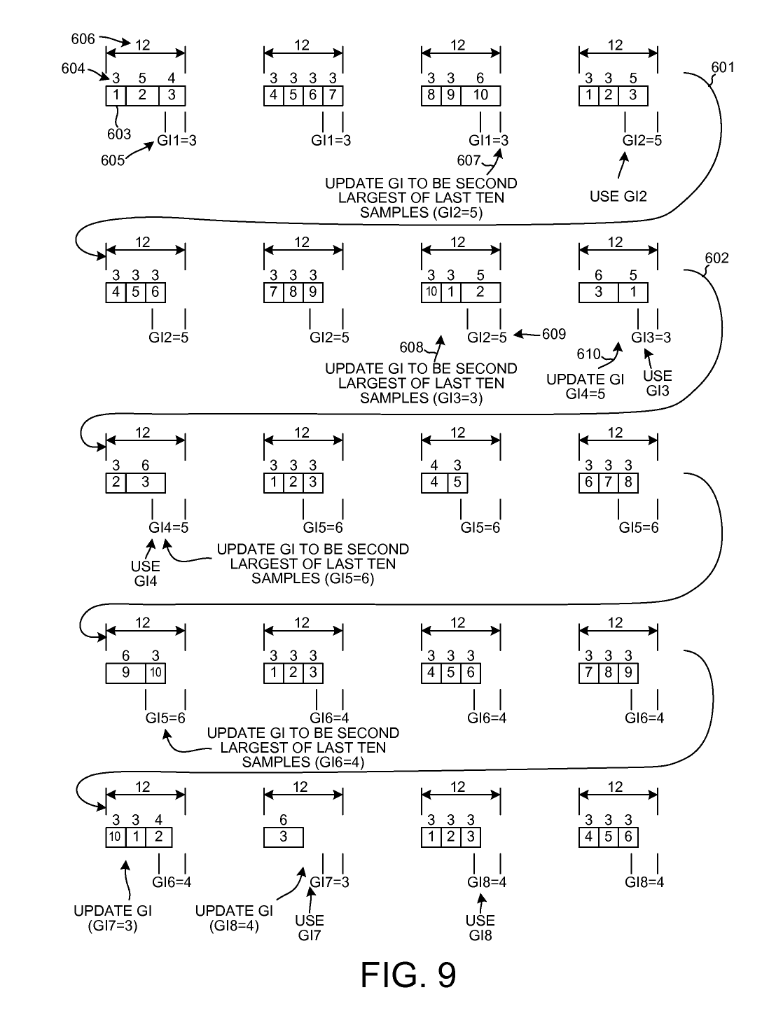

FIG. 9 is a diagram of an operational example that illustrates operation of the methods of FIG. 7 and FIG. 8. In the diagram, time extends from the upper left hand corner of the diagram, horizontally across the upper row of AP response times, then down and to the left as indicated by arrow 601 to the left side of the second row of AP response times, then to the right across the second row of AP response times, then down and back to the left as indicated by arrow 602 to the left side of the third row of AP response times, as so forth back and forth to the bottom right corner of FIG. 9. The example of FIG. 9 starts with an initial AP response time being measured. The “1” in the leftmost block 603 denotes a first PS-Poll, the corresponding first downlink data packet communication from the AP to the STA, and the ACK of the first downlink data packet. The “3” above the leftmost block 603 as indicated by arrow 604 indicates the resulting RTMV value of “3” time units. The first GI is “3” in this example as set forth by the notation 605 “GI1=3”. The “1” in this “GIl” notation indicates it is the first GI value determined. The second part of the coexistence interval in this example is twelve time units long as indicated by the “12” numeral 606 and the associated double headed arrow. In accordance with the GI-determining method, ten RTMVs are determined without changing the GI. Accordingly, after the first RTMV denoted “1” has been determined, three time units have expired and the guard interval at the end of the interval has not yet been reached. The STA therefore sends a second PS-Poll causing a second downlink data packet to be sent. In the illustrated example, this second AP response time is longer than the first. The AP response time is measured to be five units in length as indicated by the “5” above the second block denoted “2”. At this point, eight time units have expired. The three-unit GI does not, however, start until the beginning of time unit ten. Accordingly, the STA determines that the GI has not been entered and sends a third PS-Poll communication to the AP. The AP responds with a third downlink data packet denoted “3”. In the illustrated example, the third AP response time is measured to generate a third RTMV of “4”. This concludes the second part of the first coexistence interval. The subsequent first part of the first coexistence interval (the part used for Bluetooth communications) is not shown.

Next, at the beginning of the second part of the second coexistence interval, the STA issues a fourth PS-Poll. This results in a fourth RTMV of time duration “3”. The STA continues sending PS-Polls and receiving downlink data packets as illustrated until the GI (of the second part of the second coexistence interval) has been reached. In the illustrated example, four more downlink data packets denoted “4”, “5”, “6” and “7” are received. The corresponding RTMVs are “3”, “3”, “3” and “3”. Note that the GI remains fixed because ten RTMVs have not yet been received. The receipt of the seventh downlink data packet denoted “7” concludes the second part of the second coexistence interval. The first part of the second coexistence interval is then used (not shown) for Bluetooth communications.

Next, at the beginning of the second part of the third coexistence interval, the STA issues an eighth PS-Poll. This results in an eighth RTMV of time duration “3”. The STA continues sending PS-Polls and receiving downlink data packets as illustrated until the GI (of the second part of the third coexistence interval) has been reached. In the illustrated example, the tenth RTMV denoted “10” is “6” time units in duration. The first GI value GI1 of “3” is used through the first, second, and third coexistence intervals. When the tenth RTMV value is determined, then in accordance with the GI-determining policy, the GI is updated to be the second largest RTMV of the last ten RTMV values. The second largest RTMV value of the last ten RTMV values is “5” (the RTMV value of the second AP communication “2”). The GI is therefore updated to have a value of “5” as indicated by the notation GI2=5. This GI updating occurs at the time of arrow 607 at the end of the second part of the third coexistence interval. The first part of the third coexistence interval (not shown) then occurs.

Next, in accordance with the GI-determining policy, the new updated GI (GI2=5) is now used as the current GI for the fourth coexistence interval. Once the GI being used in a coexistence interval is set, it remains fixed throughout the entire second part of coexistence interval.

In the notation used in FIG. 9, once a GI has been updated the number of the next AP downlink data packet communication starts again at “1”. The STA issues a first PS-Poll at the beginning of the second part of the fourth coexistence interval and receives in response a downlink data packet from the AP. The AP response time is measured, thereby generating a RTMV value of “3”. In accordance with the GI-determining method, this new RTMV value is compared with the current GI value. If the new RTMV value is larger than the current GI value then the GI value would be updated (to be the value of the second largest RTMV of the last ten RTMVs), but if the new RTMV value is not larger than the current GI value then the GI value is not updated. In the example, the new RTMV value of “3” is not larger than the current GI value of “5”, so the GI value is not updated. At the end of the receiving of first AP communication, the guard interval at the end of the second part of the fourth coexistence interval has not bee n reached, so the STA issues another PS-Poll. The resulting second RTMV has a value of “3”, and because this is value is less than the current GI being used the GI is not updated. Again at the end of the receiving of second AP communication, the guard interval at the end of the second part of the fourth coexistence interval has not been reached, so the STA issues another PS-Poll. The resulting RTMV has a value of “5” as illustrated. The third RTMV is not larger than the current GI value of “5”, so the GI is not updated and seven more RTMV values are determined before the next GI update occurs. At the end of third AP communication (in the fourth coexistence interval), the end of the second part of the fourth coexistence interval has not yet been reached, but the guard interval has been entered. Consequently, the STA does not issue another PS-Poll. There is a quiet time one time unit in length at the end of the second part of the fourth coexistence interval as illustrated.

The sequence of events in this example proceeds as indicated by arrow 601. Seven more AP response times “4”, “5”, “6”, “7”, “8”, “9” and “10” are measured without the GI being updated. At the end of the receiving of these seven AP response times, the GI is updated in accordance with the GI-determining policy. The updated GI value is the second largest RTMV of the last ten RTMVs. In the illustrated example, the second largest RTMV of the last ten RTMVs is “3”, so the GI is updated at the time indicated by arrow 608 to be “3” as indicated by the notation “GI3=3”. The second part of the seventh coexistence interval was, however, started using a GI value of “5”. The GI value used in the seventh coexistence interval therefore remains “5” as indicated by the “GI2=5” notion 609.

After the AP response time denoted “10” has been measured at the beginning of the second part of the seventh coexistence interval, the guard interval has not yet been reached. The STA therefore issues another PS-Poll. The AP responds, and the response is measured to generate a RTMV of “3”. Because this RTMV value of “3” is not larger than the currently used GI value of “5”, the GI value is not updated. After the AP response denoted “1” has been received and measured, the guard interval at the end of the seventh coexistence interval has still not yet been reached. The STA therefore issues another PS-Poll. The AP responds again, and the response is measured to generate a RTMV of “5”. In the illustrated example, the AP response is concluded at the end of the second part of the seventh coexistence interval.

According to the GI-determining policy, if any of the next three RTMVs after a GI update is larger than the current GI, then the GI is updated immediately. Accordingly, because only two RTMVs have been made after the last updating of the GI (at the time indicated by arrow 608), the next RTMV value of “6” (the first RTMV of the eighth coexistence interval) is compared to the current GI value of “5”. In this case, the RTMV value of “6” is larger than the current GI value, so the GI is immediately updated to “5” at the time indicated by arrow 610. The new updated GI value is “5” because “5” is the second largest RTMV value of the last ten RTMV values. The notation in the diagram of “GI4=5” indicates that the GI has been updated to “5”. Because the second part of the eighth coexistence interval was started using a GI value of “3”, the GI value “3” being used is not changed until the beginning of the second part of the ninth coexistence interval.

The transmitting of PS-Polls, the making of AP response time measurements, the updating of the GI, and the using of updated GI values continues in this way for the remainder of the example of FIG. 9. Note that in the first set of ten RTMVs of FIG. 9, and in the second set of RTMVs of FIG. 9, that the GI was updated at a rate of one time every ten RTMVs. The values of the RTMVs during this time were relatively constant. But when the RTMVs values quickly increased at the end of the seventh coexistence interval such that there were a few closely spaced relatively large RTMV values then the GI-determining mechanism reacted and updated the GI within about three RTMVs, and the quickly updated GI was in use within four RTMVs at the beginning of the ninth coexistence interval. Whereas the GI-determining set forth in connection with FIG. 5 and FIG. 6 always updates the GI at constant rate of one update per ten AP response time measurements, the GI-determining set forth in connection with FIG. 9 updates the GI at a rate of one update per ten AP response time measurements if the AP response time measurements are relatively static and unchanging, but responds to substantial non-spurious increases in AP response more quickly. The rate of GI updating is higher than one update per ten RTMVs. The speed with which the GI-determining method responds, the kinds of RTMV changes to which the GI-determining method responds, and the sensitivity of the response, can all be changed by changing parameters of the GI-determining function and by applying known digital filtering techniques. The GI-determining method employed by an existing and operational cellular telephone (such as cellular telephone 2) can be changed by replacing the GI-determining program 36 with another GI-determining program.

The particular GI-determining method described in connection with FIG. 9 is but one example of a GI-determining function that adjusts the rate of GI update as a function of AP response time measurements. Rather than ten RTMVs being collected in the initial cycle of the policy and the second largest of these being used as the next GI, a number other than ten can be used. The function of these RTMVs that determines the next GI need not be the “second largest” of the last ten RTMVs, but rather can be another function of the last ten RTMV. Rather than the next three RTMVs being considered to determine whether one of these three RTMVs is bigger than the current GI, a number other than three can used. Also, rather than the test (for determining whether to update GI immediately) being whether one of the three RTMVs is larger than the GI, the test can be whether one of the three RTMVs is more than a certain amount greater than the current GI. The way the determination of the GI is made at a different rate as a function of the values of the stream of RTMVs can be different in different embodiments. The rate at which the GIs is determined is not, however, just a fixed rate, but rather is adjusted under some conditions of the stream of input RTMV values such that the rate is increased if the AP quickly changes the data rate with which it communicates data packets back to the STA. Rather than the GI-determining function using only RTMVs to determine when to update the GI, the GI-determining function can also consider additional input information and can use that information along with RTMVs to determine when to update the GI and when to start using the GI. The additional input information can include information about the operating environment of the cellular telephone 2.

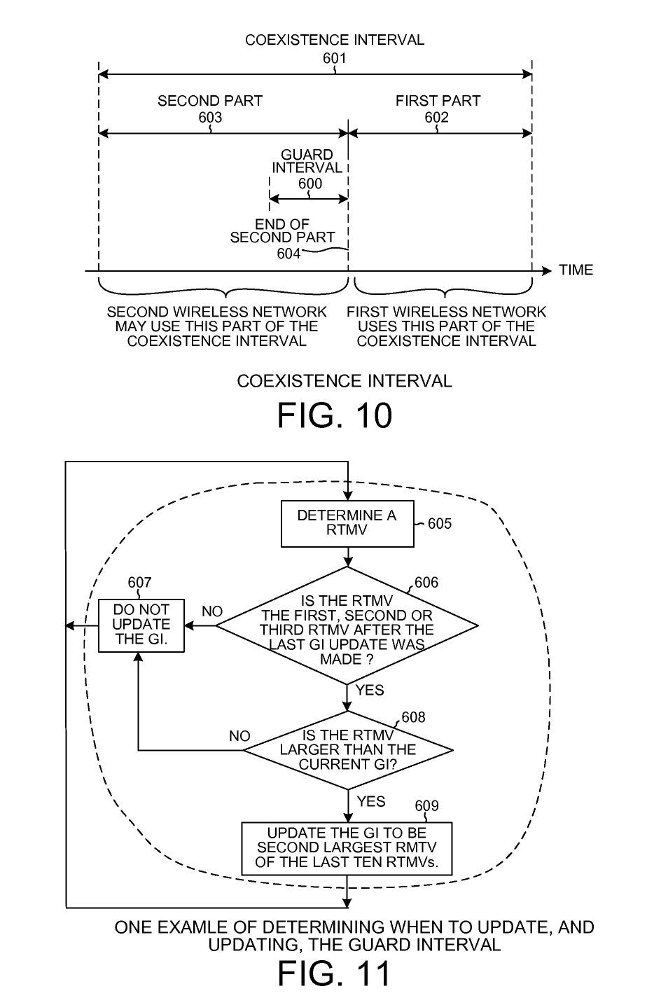

FIG. 10 is a diagram that illustrates a generic wireless coexistence interval that includes a guard interval 600 that is adjusted. The rate of guard interval adjustment changed based at least in part on an incoming value (for example, an RTMV). The generic coexistence interval 601 includes a first part 602 that is used by a first wireless network. The coexistence interval 601 also includes a second part 603 that is usable by a second wireless network. Reference numeral 604 indicates the end of the second part 603 of the coexistence interval. The method of changing GI adjustment rate has general applicability and is not limited to the first wireless network being a Bluetooth network, nor is the method limited to the second wireless network being a WLAN network, nor is the method of changing GI adjustment rate limited to any particular type of coexistence interval.

FIG. 11 is a flowchart of a specific example of the general method of FIG. 7. The specific example of FIG. 11 is the example used in the operational example of FIG. 9. A RTMV is determined (step 605). If the RTMV is not the one of the first, second, or third RTMVs received after the last GI update (step 606), then the GI is not updated (step 607). If, however, the RTMV is one of the first, second, or third RTMVs received after the last GI update (step 606), then it is determined (step 608) whether the RTMV is larger than the current GI. If the RTMV is larger than the current GI (step 608), then the GI is updated (step 609) to be second largest RTMV of the last ten RTMVs received. If, on the other hand, the RTMV is not larger than the current GI (step 608), then the GI is not updated (step 607). This method of determining when to update the GI and of determining what the value of the updated GI will be is performed once for every RTMV determined in step 605.

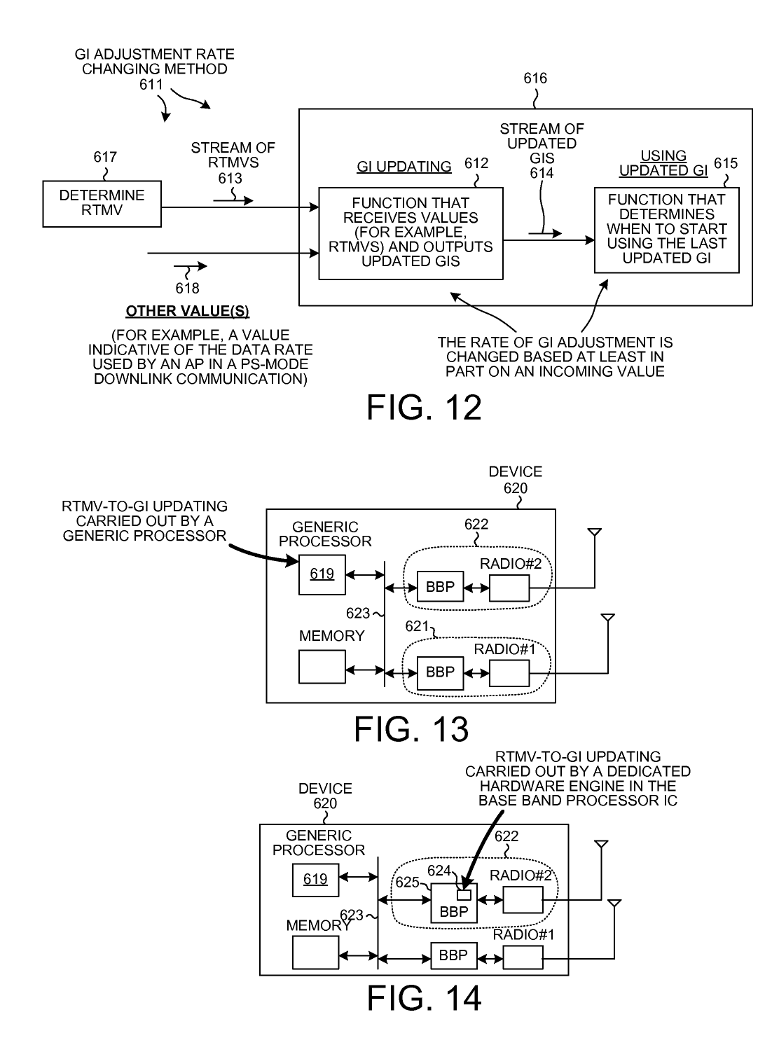

FIG. 12 is another diagram illustrative of a Guard Interval adjustment rate changing method 611 and a structure for carrying out the method. A first functionality 612 receives a stream 613 of values (for example, RTMVs) and outputs a stream 614 of updated GIs. A second functionality 615 receives the stream 614 of updated GIs and determines when to start using the last updated GI. Functionalities 612 and 615 together are a functionality 616 that changes the GI adjustment rate based at least in part on an incoming value (for example, an incoming RTMV). The GI adjustment rate can be changed based on one or more RTMVs received from an RTMV determining functionality 617. The GI adjustment rate can be changed based on one or more other values. Examples of one 618 of these other values include: a digital value communicated from an Access Point (AP) to a station (STA) across the second wireless network, a value indicative of a communication data rate, a value indicative of an interference condition, a value indicative of a communication channel condition, and a value indicative of an operating mode of the second wireless network. The first functionality 612 may change the GI adjustment rate based one any one of these values, or on multiple different ones of these values. Although the GI adjustment rate changing method is described above in connection with an example in which the method is carried out by processor 31, the method can be performed in whole or in part by other circuits in other examples. In one example, the function performed by one of the functionalities is described in a hardware description language and then a dedicated circuit to perform that function is synthesized into netlist of digital logic components. The netlist is then fabricated as an integrated circuit such that each of functionalities 612, 615 and 617 is realized as a separate hardware circuit of digital logic.

FIG. 13 is a diagram that illustrates how the method of determining an updated GI and of determining when to use the updated GI can be performed by a generic processor 619 that executed instructions stored in a memory. A device 620 includes the generic processor 619, a first wireless transceiver 621 for communicating in a first wireless network and a second wireless transceiver 622 for communicating in a second wireless network. The first wireless transceiver may make response time measurements, and the resulting RTMVs may be passed via bus mechanism 623 to the generic processor 619. The generic processor 619 may then determine the updated GI and when to start using it, and may instruct the wireless transceiver circuitry 620 accordingly.

FIG. 14 is a diagram that illustrates how the method of determining an updated GI and of determining when to use the updated GI can be performed by a dedicated amount of dedicated digital logic hardware or hardware engine 624. In this example, the dedicated hardware engine 624 is part of a baseband integrated circuit 625 in the transceiver 626 for communicating in the second wireless network.

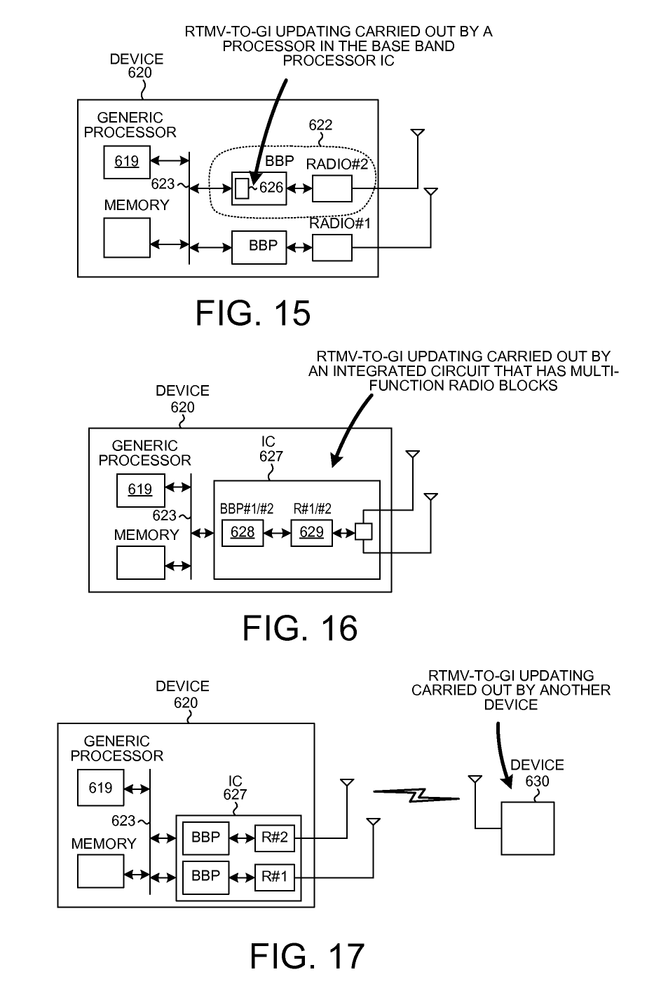

FIG. 15 is a diagram that illustrates how the method of determining an updated GI and of determining when to use the updated GI can be performed by a processor 626 in the transceiver 622 for communicating in the second wireless network.

FIG. 16 is a diagram that illustrates how the method of determining an updated GI and of determining when to use the updated GI can be performed by an integrated circuit 627 that has multi-function radio blocks 628 and 629. Integrated circuit 627 functions as a transceiver for communicating in the first wireless network if the multi-function radio blocks 628 and 629 are configured in a first way, and integrated circuit 627 functions as a transceiver for communicating in the second wireless network if the multi-function radio blocks 628 and 629 are configured in a second way. Multi-function radio block 628 is a multi-function base band processor portion and multi-function radio block 629 is a multi-function RF transceiver portion.

FIG. 17 is a diagram that illustrates how the method of determining an updated GI and of determining when to use the updated GI can be performed by functionality 630 outside device 620. Device 130 may, for example, be in communication with device 620 via the second wireless network. In another example, functionality 630 is coupled to device 620 by a hardwired connection. Both devices 620 and 630 may be parts of a single larger piece of electronic equipment disposed in a single enclosure.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In one specific example, memory 35 of the WLAN baseband processor integrated circuit 35 of FIG. 2 is a processor-readable medium (computer-readable medium) that stores a set of processor-executable instructions 36 (computer-executable instructions), where execution of this set of processor-executable instructions by processor 31 causes the GI-determining and GI rate adjustment methods described above to be carried out.

Although certain specific embodiments are described above for instructional purposes, the teachings of this patent document have general applicability and are not limited to the specific embodiments described above. Although the GI-determining and GI rate adjustment method is described above in connection with WLAN and Bluetooth coexistence, the method is applicable to facilitating coexistence between networks other than WLAN and Bluetooth networks. The method applies to coexistence intervals of various different types and formats and is not limited to use with the particular coexistence interval format set forth in connection with FIG. 4. The method is not limited to use with the PS-Poll mechanism of requesting single downlink data packets, but rather is of general applicability. Response time measurements can be made of network communications other than PS-Poll requested communications. Although examples are described above in which the response time being measured starts at the time of a PS-Poll transmission and concludes at the time of an ACK transmission, the response time being measured in other examples is measured starting and stopping at other points in one or more wireless communications. Although the WLAN transceiver circuitry can be implemented in multiple integrated circuits 24 and 25 as illustrated in FIG. 2, in another embodiment the circuitry of integrated circuits 24 and 25 is integrated onto a single integrated circuit. Accordingly, various modifications, adaptations, and combinations of the various features of the described specific embodiments can be practiced without departing from the scope of the claims that are set forth below.

What is claimed is:

1. A method comprising:
changing a Guard Interval (GI) adjustment rate based at least in part on a value, wherein the GI is an amount of time at an end of a second part of a coexistence interval, wherein the coexistence interval includes a first part reserved for communication in a first wireless network, and wherein the second part of the coexistence interval is usable for communication in a second wireless network and is not used for communication in the first wireless network.

2. The method of claim 1, wherein the value is a value taken from the group consisting of: a Response Time Measurement Value (RTMV) indicative of a response time of a communication in the second wireless network, a digital value communicated from an Access Point (AP) to a station (STA) across the second wireless network, a value indicative of a communication data rate, a value indicative of an interference condition, a value indicative of a communication channel condition, and a value indicative of an operating mode of the second wireless network.

3. The method of claim 1, wherein the GI adjustment rate is a number of GI adjustments per downlink communication in the second wireless network.

4. The method of claim 1, wherein the GI adjustment rate is a number of times that the GI is changed within a time period divided by a number of communications that occurred in the time period.

5. The method of claim 1, wherein an adjustment of the GI involves:
updating the GI in response to a Response Time Measurement Value (RTMV) and thereby obtaining an updated GI; and
using the updated GI to determine whether a communication will be initiated during a coexistence interval.

6. The method of claim 1, further comprising:
determining a Response Time Measurement Value (RTMV) indicative of a response time of a communication in the second wireless network; and
using the RTMV to determine when to change the GI adjustment rate.

7. The method of claim 1, wherein the second wireless network is a Wireless Local Area Network (WLAN), wherein the first wireless network is a Bluetooth network, wherein the coexistence interval is a six-slot Bluetooth transmission interval, wherein the first part of the coexistence interval includes some of the slots of the Bluetooth transmission interval, wherein the second part of the coexistence interval includes others of the slots of the Bluetooth transmission interval, and wherein the changing of the GI adjustment rate is performed by a device that communicates in the second wireless network.

8. The method of claim 1, further comprising:
using the GI to schedule communications in the second wireless network.

9. A method comprising:
(a) determining a Response Time Measurement Value (RTMV) indicative of a response time of a communication in a second wireless network; and
(b) determining when to update a Guard Interval (GI) based at least in part on the RTMV, wherein the GI is an amount of time at an end of a second part of a coexistence interval, wherein the coexistence interval includes a first part reserved for communication in a first wireless network, and wherein the second part of the coexistence interval is not used for communication in the first wireless network.

10. The method of claim 9, wherein the second wireless network is a Wireless Local Area Network (WLAN), wherein the first wireless network is a Bluetooth network, wherein the coexistence interval is a six-slot Bluetooth transmission interval, wherein the first part of the coexistence interval includes some of the slots of the Bluetooth transmission interval, and wherein the second part of the coexistence interval includes others of the slots of the Bluetooth transmission interval.

11. The method of claim 10, wherein the response time is an Access Point (AP) response time.

12. The method of claim 9, wherein the determining of when to update the GI in (b) involves using the RTMV as an input value to a function such that the function outputs an output value, wherein if the output value is a first value then the GI is updated whereas if the output value is a second value then the GI is not updated but rather remains unchanged until at least another RTMV is determined.

13. The method of claim 9, wherein the determining of the RTMV in (a) involves determining an amount of time elapsed between a first time when a PS-Poll communication is sent to an Access Point (AP) and a second time when an acknowledgement (ACK) of a response to the PS-Poll communication is sent to the AP.

14. The method of claim 9, wherein (a) and (b) are performed on a Wireless Local Area Network (WLAN) station (STA), wherein the response time is an Access Point (AP) response time, the method further comprising:
(c) updating the GI in response to the determining of (b); and
(d) using the updated GI on the WLAN STA to determine whether a PS-Poll request will be sent to the AP during the amount of time at the end of a second part of a coexistence interval.

15. The method of claim 9, wherein (a) and (b) are performed on a Wireless Local Area Network (WLAN) station (STA), wherein the response time is an Access Point (AP) response time, the method further comprising:
(c) updating the GI in response to the determining of (b); and
(d) using the updated GI on the WLAN STA to determine whether a PS-Poll request will be sent to the AP during an amount of time of a second coexistence interval.

16. The method of claim 9, the method further comprising:
(c) updating the GI in response to the determining of (b); and
(d) using the updated GI to determine whether a downlink data packet will be communicated across the second network in a coexistence interval.

17. The method of claim 9, the method further comprising:
(c) updating the GI in response to the determining of (b); and
(d) using the updated GI to determine whether a downlink data packet will be communicated across the second network in a second coexistence interval.

18. A method comprising:
(a) using a first GI in a first coexistence interval to determine whether to communicate information across a second wireless network during an end portion of the first coexistence interval, wherein the first coexistence interval includes a first part reserved for communication in a first wireless network, wherein the coexistence interval includes a second part not used for communication in the first wireless network, and wherein the end portion is an end portion of the second part;
(b) making at least one response time measurement indicative of a response time of a communication in the second wireless network and thereby obtaining at least one Response Time Measurement Value (RTMV); and
(c) determining whether to use the first GI in a second coexistence interval or whether to use a second GI in the second coexistence interval, wherein the determining of (c) is based at least in part on the RTMV.

19. The method of claim 18, wherein the determining of (c) involves using the RTMV as an input value to a function such that the function outputs an output value, wherein if the output value is a first value then the second GI is used in the second coexistence interval whereas if the output value is a second value then the first GI is used in the second coexistence interval.

20. A Wireless Local Area Network (WLAN) station (STA) that changes a Guard Interval (GI) adjustment rate based at least in part on a value, wherein the GI is an amount of time at an end of a second part of a coexistence interval, wherein the coexistence interval includes a first part reserved for communication in a first wireless network, and wherein the second part of the coexistence interval is usable for communication in a second wireless network and is not used for communication in the first wireless network.

21. The WLAN STA of claim 20, wherein the value is a value taken from the group consisting of: a Response Time Measurement Value (RTMV) indicative of a response time of a communication in the second wireless network, a digital value communicated from an Access Point (AP) to a station (STA) across the second wireless network, a value indicative of a communication data rate, a value indicative of an interference condition, a value indicative of a communication channel condition, and a value indicative of an operating mode of the second wireless network.

22. The WLAN STA of claim 20, wherein the WLAN STA determines the value by transmitting a PS-Poll communication, receiving a response to the PS-Poll communication, transmitting an acknowledgement of the response, and determining the value to be a value indicative of a period of time between a first time when the PS-Poll communication is transmitted and a second time when the acknowledgment is transmitted.

23. The WLAN STA of claim 20, wherein the GI is a guard interval within a Bluetooth communication interval, and wherein both a WLAN communication and a Bluetooth communication occur during the Bluetooth communication interval.

24. The WLAN STA station of claim 20, wherein the WLAN STA communicates in compliance with an IEEE 802.11 standard.

25. A device comprising:
Wireless Local Area Network (WLAN) transceiver circuitry that is controllable to communicate during a second part of a Bluetooth transmission interval, wherein a Bluetooth communication occurs during in a first part of the Bluetooth transmission interval; and
a processor circuit operatively coupled to the WLAN transceiver circuitry, wherein the processor circuit determines when to adjust a coexistence Guard Interval (GI) based at least in part on a Response Time Measurement Value (RTMV), and wherein the RTMV is a measurement value indicative of an WLAN Access Point (AP) response time.

26. The device of claim 25, wherein the device is an integrated circuit, and wherein the WLAN transceiver circuitry is configured to receive WLAN signals from an antenna external to the integrated circuit, and wherein the WLAN transceiver circuitry is configured to output WLAN signals to the antenna.

27. The device of claim 25, wherein the processor circuit determines when to adjust the GI by using the RTMV as an input value to a function such that the function outputs an output value, wherein if the output value is a first value then the GI is updated whereas if the output value is a second value then the GI is not updated but rather remains unchanged until at least another RTMV is determined.

28. The device of claim 25, wherein the processor determining when to adjust the GI results in an updated GI being determined, and wherein the processor further determines when to use the updated GI in scheduling WLAN communications.

29. The device of claim 25, further comprising:
a Bluetooth transceiver circuitry operatively coupled to the processor circuit, wherein the Bluetooth transceiver circuitry takes part in the Bluetooth communication that occurs during the first part of the Bluetooth transmission interval.

30. A device comprising:
Wireless Local Area Network (WLAN) transceiver circuitry that is controllable to communicate during a second part of a Bluetooth transmission interval, wherein a Bluetooth communication occurs during in a first part of the Bluetooth transmission interval; and
means for determining when to adjust a coexistence Guard Interval (GI) based at least in part on a Response Time Measurement Value (RTMV), wherein the RTMV is a measurement value indicative of a WLAN Access Point response time.

31. The device of claim 30, wherein the means is also for using the GI to determine whether to initiate a sending of a PS-Poll communication to an Access Point (AP).

32. The device of claim 30, wherein the means determines when to adjust the GI by using the RTMV as an input value to a function such that the function outputs an output value, wherein if the output value is a first value then the GI is updated before another RTMV is determined whereas if the output value is a second value then the GI is not updated and remains unchanged until after said other RTMV has been determined.

33. The device of claim 30, wherein the means includes a processor and a memory, wherein the memory stores processor-executable instructions that are executed by the processor, and wherein the processor is operatively coupled to the WLAN transceiver circuitry.

34. A processor-readable medium storing a set of processor-executable instructions, wherein execution of the set of processor-executable instructions by a processor is for:
determining when to adjust a coexistence Guard Interval (GI) based at least in part on a Response Time Measurement Value (RTMV), wherein the RTMV is a measurement value indicative of a Wireless Local Area Network (WLAN) Access Point (AP) response time.

35. The processor-readable medium of claim 34, wherein execution of the set of processor-executable instructions by a processor is also for:
causing a response time measurement to be made such that the RTMV is determined.

36. The processor-readable medium of claim 35, wherein making the response time measurement involves determining an amount of time elapsed between a first time when a PS-Poll communication is sent to an Access Point (AP) and a second time when an acknowledgement (ACK) of a response to the PS-Poll communication is sent to the AP.

37. The processor-readable medium of claim 34, wherein execution of the set of processor-executable instructions by a processor is also for:
using the coexistence GI in a determining of whether to generate a PS-Poll request during a coexistence interval.

38. The processor-readable medium of claim 34, wherein the processor and the processor-readable medium are parts of an integrated circuit, and wherein the integrated circuit further comprises a WLAN transceiver.

39. The processor-readable medium of claim 34, wherein the determining of when to adjust the coexistence GI involves supplying the RTMV as an input value to a function such that the function outputs an output value, wherein execution of the set of processor-executable instructions by the processor is also for:
updating the coexistence GI before another RTMV is determined if the output value is a first value whereas if the output value is a second value then the coexistence GI is not updated and remains unchanged until after said another RTMV has been determined.
